(19) United States
(12) Patent Application Publication
(10) Pub. No.: US 2026/0136149 A1
(43) Pub. Date: May 14, 2026

(54) VIRTUAL MAPPING FOR DISTRIBUTED HETEROGENEOUS DEVICES WITH SPEAKER AND MICROPHONE

(71) Applicant: Samsung Electronics Co., Ltd., Suwon-si (KR)

(72) Inventors: Vishnu Vardhan Ratnam, Frisco, TX (US); Wei Sun, Frisco, TX (US); Hao Chen, Allen, TX (US)

(21) Appl. No.: 19/383,419

(22) Filed: Nov. 7, 2025

Related U.S. Application Data
(60) Provisional application No. 63/720,691, filed on Nov. 14, 2024.

(51) Int. Cl. H04S 7/00; G01S 5/18; G01S 5/26

(52) U.S. Cl. CPC H04S 7/302; G01S 5/186; G01S 5/26; H04S 7/40; H04S 2400/11

(57) ABSTRACT

A system for virtual mapping for distributed heterogeneous devices with speaker and microphone is provided. The system includes a transceiver and a processor operably connected to the transceiver. The processor is configured to control a set of target devices to emit or measure acoustic signals. Each target device has a capability of emitting and receiving acoustic signals. The processor is configured to process the acoustic signals to at least reduce random jitters, clock offsets, or both the random jitters and the clock offsets. The processor is configured to determine pairwise distances for the set of target devices based on the processed acoustic signals. The processor is configured to map the pairwise distances for each target device among the set of target devices into distances between a set of points in a multidimensional space.

### CROSS-REFERENCE TO RELATED APPLICATION(S) AND CLAIM OF PRIORITY

This application claims priority under 35 U.S.C. § 119 (e) to U.S. Provisional Patent Application No. 63/720,691 filed on Nov. 14, 2024. The above-identified provisional patent application is hereby incorporated by reference in its entirety.

### TECHNICAL FIELD

This disclosure relates generally to device localization systems. More specifically, this disclosure relates to virtual mapping for distributed heterogeneous devices with speaker and microphone.

### BACKGROUND

Localizing multiple devices in a physical environment is important to map these devices in Augmented Reality (AR)/Virtual Reality (VR). By constructing the spatial location of these devices in AR/VR, a user can have favorable Human-Computer Interaction (HCl) experience. Localization of multiple devices also plays a key role in several other use cases such as smart home automation, multi-device screen sharing/extension etc.

Existing localization technologies require rendering the 3D model of the whole space such as using multi-view images and LiDAR scanning. The accuracy of the multi-view images and LiDAR scanning is high enough to enable VR applications, but such this scanning and rendering of the 3D model requires specialized equipment and comprehensive calibration to set up the measurement.

Another track of methodology applies a master device with the antenna array to localize a target device with distance measurements and angular measurement using wireless modulated signals such as WiFi, Bluetooth, and UWB. However, both accuracy and resolution of the distance and angular measurement are not sufficient to map the target location correctly in a virtual world.

### SUMMARY

This disclosure provides virtual mapping for distributed heterogeneous devices with speaker and microphone.

In one embodiment, a system for virtual mapping for distributed heterogeneous devices with speaker and microphone is provided. The system includes a transceiver; and a processor operably connected to the transceiver. The processor is configured to control a set of target devices to emit or measure acoustic signals. Each target device has a capability of emitting and receiving acoustic signals. The processor is configured to process the acoustic signals to at least reduce random jitters, clock offsets, or both the random jitters and the clock offsets. The processor is configured to determine pairwise distances for the set of target devices based on the processed acoustic signals. The processor is configured to map the pairwise distances for each target device among the set of target devices into distances between a set of points in a multidimensional space.

In another embodiment, a method for virtual mapping for distributed heterogeneous devices with speaker and microphone is provided. The method is implemented by at least one processor operably connected to a transceiver. The method includes controlling a set of target devices to emit or measure acoustic signals. Each target device has a capability of emitting and receiving acoustic signals. The method includes processing the acoustic signals to at least reduce random jitters, clock offsets, or both the random jitters and the clock offsets. The method includes determining pairwise distances for the set of target devices based on the processed acoustic signals. The method includes mapping the pairwise distances for each target device among the set of target devices into distances between a set of points in a multidimensional space.

In yet another embodiment, a non-transitory computer readable medium comprising program code for virtual mapping for distributed heterogeneous devices with speaker and microphone is provided. The computer program includes computer readable program code that when executed causes a processor of an electronic device to control a set of target devices to emit or measure acoustic signals. Each target device has a capability of emitting and receiving acoustic signals. The computer readable program code causes the processor to process the acoustic signals to at least reduce random jitters, clock offsets, or both the random jitters and the clock offsets. The computer readable program code causes the processor to determine pairwise distances for the set of target devices based on the processed acoustic signals. The computer readable program code causes the processor to map the pairwise distances for each target device among the set of target devices into distances between a set of points in a multidimensional space.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example electronic device in accordance with an embodiment of this disclosure;

FIG. 3 illustrates an example user equipment in accordance with an embodiment of this disclosure;

FIGS. 4A and 4B illustrate examples of a multiple-device localization system according to embodiments of this disclosure illustrates an example block diagram in accordance with an embodiment of this disclosure;

FIG. 5 illustrates a block diagram of an automatic acoustic localization system implementing virtual mapping for multiple heterogeneous devices according to embodiments of this disclosure;

FIG. 6 illustrates a user interface (UI) interactor according to embodiments of this disclosure;

FIG. 7 illustrates a method for operating an acoustic anchor in accordance with an embodiment of this disclosure;

FIG. 8 illustrates an audio recording timestamp model of an acoustic anchor to play and record audio according to embodiments of this disclosure;

FIG. 9 illustrates a method for operating an orchestrator in accordance with an embodiment of this disclosure;

FIG. 10 illustrates an example of the management protocol in which the orchestrator requests all the anchors to start measurement over a common large time window, according to embodiments of this disclosure;

FIG. 11 illustrates an algorithm performed by the aggregator to integrate the global information of all acoustic anchors to reconstruct the geometry map, according to embodiments of this disclosure;

FIG. 12A illustrates a home layout available at a smart home application or platform that can be accessed by the VMHD app, according to embodiments of this disclosure;

FIG. 12B illustrates a mobile target localization algorithm implemented using a set of acoustic anchor devices, according to embodiments of this disclosure; and

FIG. 13 illustrates a method for accurate virtual mapping for distributed heterogeneous devices with speaker and microphone in accordance with an embodiment of this disclosure in accordance with an embodiment of this disclosure.

### DETAILED DESCRIPTION

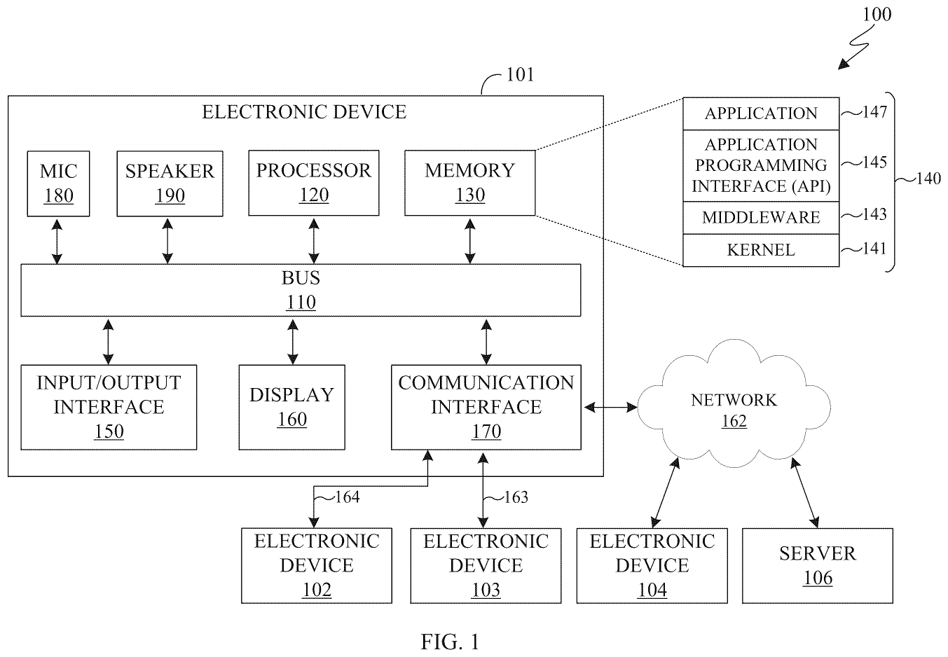

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged wireless communication system or device.

Detecting the dynamic relative location of target devices is important in extended reality (XR)/VR applications, among others. For instance, the VR system needs to distinguish the left handle from the right handle and visualize them in the user interface correctly. One problem is that some technology requires users to input a selection of their dominant hands, respectively. Another problem is that other technologies require use of specialized sensors and procedure to determine the relative location. These methods are not scalable when they come across a large number of heterogeneous devices, including mobile phones, laptops, smart watches, tablets of different brand. Manual set up is challenging to users, and this problem is exacerbated by an emerging trend in which more and more devices will be included in the VR set up. Using a camera and the LiDAR to scan the target devices can build them into a virtual 3D mode, however, the methodology still requires users to perform a lot of operations (multiple operations). Thus, an effective scalable solution is needed to map the heterogeneous devices into the virtual space accurately and automatically (without human input). The embodiments of this disclosure solve multiple of these problems.

Various embodiments of the present disclosure provide a lightweight and cost-effective technique for multiple device localization to enable increasing smart devices at home. Various embodiments of the present disclosure provide a complete system to build a virtual localization map of heterogeneous devices that are equipped with a pair of speaker and microphone.

More particularly, various embodiments of the present disclosure provide a technology that includes multiple features. As one, this disclosure provides a method for accurate estimation of relative positions of anchor devices (also referred to as anchors or target devices) that have a capability of transmitting and receiving audio signals. As another, this disclosure provides an orchestrator device executes a method to initiate and coordinate the audio signal transmission and reception. As a third, this disclosure provides an accumulator device that executes a method to collect the relevant measurements from the anchors and the algorithms to estimate the relative positions of the anchor devices. As a fourth, this disclosure provides the design of a user interface to enable solving a rotational ambiguity issue.

The technology provided in this disclosure achieves multiple technical advantages. For example, embodiments of this disclosure map multiple positions of multiple target devices into an AR or VR space, based on multiple pairwise distances for the multiple target devices measured via acoustic sensing. As a further example, embodiments of this disclosure provide an acoustic measurement and communication protocol among multiple target devices to improve accuracy for measuring pairwise distances based on cancelling out random jitters and clock offsets.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

As shown in FIG. 1, according to embodiments of this disclosure, an electronic device 101 is included in the network configuration 100. The electronic device 101 may include at least one of a bus 110, a processor 120, a memory 130, an input/output (I/O) interface 150, a display 160, and a communication interface 170. The electronic device 101 may also include a microphone 180 and a speaker 190. In some embodiments, the electronic device 101 may exclude at least one of the components or may add another component.

The bus 110 may include a circuit for connecting the components 120-190 with one another and transferring communications (such as control messages and/or data) between the components. The processor 120 may include one or more of a central processing unit (CPU), an application processor (AP), or a communication processor (CP). The processor 120 may perform control on at least one of the other components of the electronic device 101 and/or perform an operation or data processing relating to communication.

The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor 120 can be a graphics processor unit (GPU). As described in more detail below, the processor 120 may perform one or more operations for accurate virtual mapping for distributed heterogeneous devices with speaker and microphone.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS). The applications 147 include a virtual mapping for heterogeneous devices application (“VMHD” app 363), which is described more particularly below.

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions of an orchestrator, an acoustic anchor, an aggregator, and a user interface (UI) interactor for accurate virtual mapping for distributed heterogeneous devices with speaker and microphone as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the application 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external devices.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170 may set up communication between the electronic device 101 and an external electronic device (such as a first electronic device 102, a second electronic device 104, a third electronic device 103, or a server 106). For example, the communication interface 170 may be connected with a network 162, 163, or 164 through wireless or wired communication to communicate with the external electronic device. The communication interface 170 can be a wired or wireless transceiver or any other component for transmitting and receiving signals.

The first external electronic device 102 or the second external electronic device 104 may be a wearable device or an electronic device 101-mountable wearable device (such as a head mounted display (HMD)). When the electronic device 101 is mounted in an HMD (such as the first external electronic device 102), the electronic device 101 may detect the mounting in the HMD and operate in a virtual reality mode. When the electronic device 101 is mounted in the first external electronic device 102 (such as the HMD), the electronic device 101 may communicate with the first external electronic device 102 through the communication interface 170. The electronic device 101 may be directly connected with the first external electronic device 102 to communicate with the first external electronic device 102 without involving with a separate network.

The wireless communication may use at least one of, for example, long term evolution (LTE), long term evolution-advanced (LTE-A), code division multiple access (CDMA), wideband code division multiple access (WCDMA), universal mobile telecommunication system (UMTS), wireless broadband (WiBro), or global system for mobile communication (GSM), as a cellular communication protocol. The wired connection may include at least one of, for example, universal serial bus (USB), high-definition multimedia interface (HDMI), recommended standard 232 (RS-232), or plain old telephone service (POTS). The network 162 may include at least one communication network, such as a computer network (like a local area network (LAN) or wide area network (WAN)), the Internet, or a telephone network.

The first and second external electronic devices 102 and 104 each may be a device of the same type or a different type from the electronic device 101. According to embodiments of this disclosure, the server 106 may include a group of one or more servers. Also, according to embodiments of this disclosure, all or some of the operations executed on the electronic device 101 may be executed on another or multiple other electronic devices (such as the first and second external electronic devices 102 and 104 or server 106). Further, according to embodiments of this disclosure, when the electronic device 101 should perform some function or service automatically or at a request, the electronic device 101, instead of executing the function or service on its own or additionally, may request another device (such as the first and second external electronic devices 102 and 104 or server 106) to perform at least some functions associated therewith. The other electronic device (such as the first and second external electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

While FIG. 1 shows that the electronic device 101 includes the communication interface 170 to communicate with the external electronic device 102, 103, or 104 or server 106 via the network(s) 162, 163, and 164, the electronic device 101 may be independently operated without a separate communication function, according to embodiments of this disclosure. Also, note that the external electronic device 102 or 104 or the server 106 could be implemented using a bus, a processor, a memory, a I/O interface, a display, a communication interface, and an event processing module (or any suitable subset thereof) in the same or similar manner as shown for the electronic device 101. As another example, each of the networks 163-164 can be a peer-to-peer connection.

The server 106 may operate to drive the electronic device 101 by performing at least one of the operations (or functions) implemented on the electronic device 101. For example, the server 106 may include a VMHD module (not shown) that may support the application 147 (for example, support the VMHD app) implemented in the electronic device 101. The VMHD module can perform (or instead perform) at least one of the operations (or functions) conducted by the orchestrator or aggregator. The event processing module 180 may process at least part of the information obtained from other elements (such as the processor 120, memory 130, input/output interface 150, or communication interface 170) and may provide the same to the user in various manners.

Although FIG. 1 illustrates one example of a network configuration 100, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

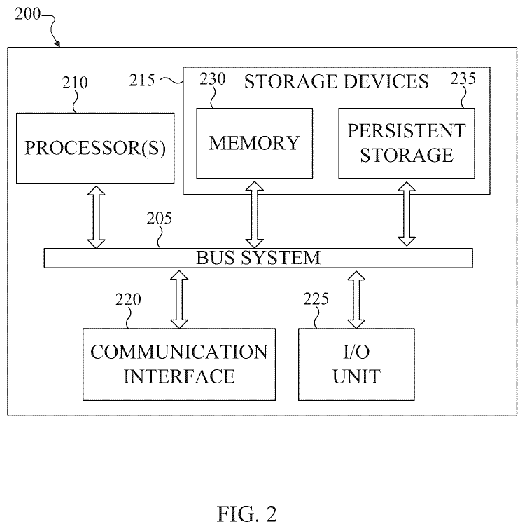

FIG. 2 illustrates an example electronic device in accordance with an embodiment of this disclosure. In particular, FIG. 2 illustrates an example server 200, and the server 200 could represent the server 106 in FIG. 1. The server 200 can represent one or more encoders, decoders, local servers, remote servers, clustered computers, and components that act as a single pool of seamless resources, a cloud-based server, and the like. The server 200 can be accessed by one or more of the electronic devices 101-104 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry. In certain embodiments, the processors 210 can include a VMHD module, which includes at least one of the processors 210 and at least some of the storage devices 215), that can perform at least one of the operations (or functions) conducted by the orchestrator or aggregator associated with the VMHD app.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random-access memory or any other suitable volatile or non-volatile storage device(s). For example, the instructions stored in the memory 230 can include instructions for accurate virtual mapping for distributed heterogeneous devices with speaker and microphone. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can establish a connection to the first electronic device 101 or the second electronic device via the network 162. The communications interface 220 can transmit, to another device such as one of the electronic devices 101-104, a schedule assigning an order of acoustic signal transmissions among the electronic devices 101-104. As another example, the communications interface 220 can receive distributed information from each among a set of acoustic target devices such as the electronic devices 101-104, and perform global optimization to construct an optimized geometry structure for the set of acoustic target devices based on the distributed information aggregated.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 106 of FIG. 1, the same or similar structure could be used in one or more of the various electronic devices 101-104. For example, a desktop computer or a laptop computer could have the same or similar structure as that shown in FIG. 2.

Although FIG. 2 illustrates an example of an electronic device, various changes can be made to FIG. 2. For example, various components in FIG. 2 could be combined, further subdivided, or omitted and additional components could be added according to particular needs. As a particular example, the processor 210 could be divided into multiple processors, such as one or more central processing units (CPUs) and one or more graphics processing units (GPUs). In addition, as with computing and communication, electronic devices and servers can come in a wide variety of configurations, and FIG. 2 does not limit this disclosure to any particular electronic device or server.

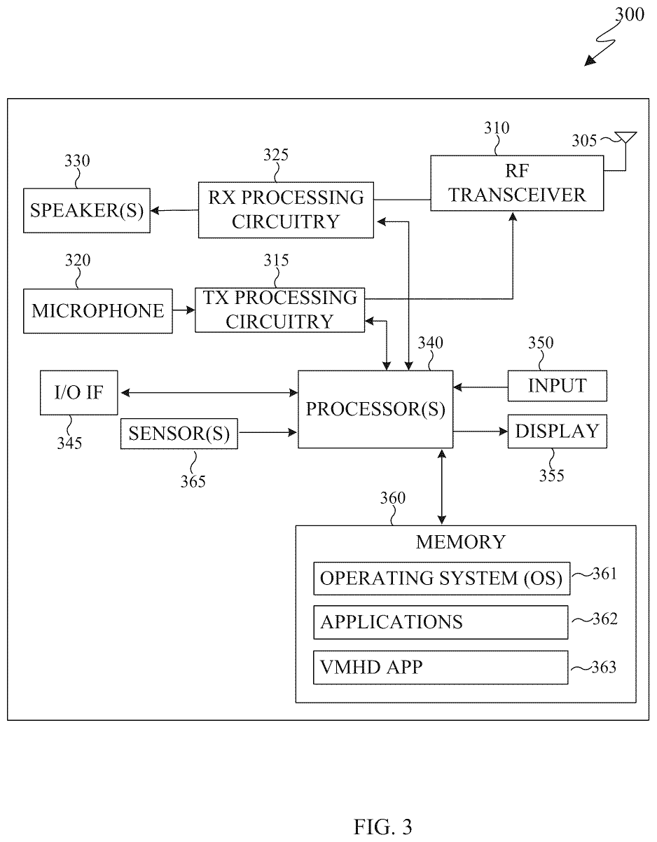

FIG. 3 illustrates an example user equipment (UE) 300 according to embodiments of the present disclosure. The embodiment of the UE 300 illustrated in FIG. 3 is for illustration only, and the electronic devices 101-104 of FIG. 1 could have the same or similar configuration. However, UEs come in a wide variety of configurations, and FIG. 3 does not limit the scope of this disclosure to any particular implementation of a UE.

As shown in FIG. 3, the UE 300 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

As described in more detail below, the UE 300 can support accurate virtual mapping for distributed heterogeneous devices with speaker and microphone.

Although FIG. 3 illustrates one example of UE 300, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 300 configured as a mobile telephone or smartphone, UEs could be configured to operate as other types of mobile or stationary devices.

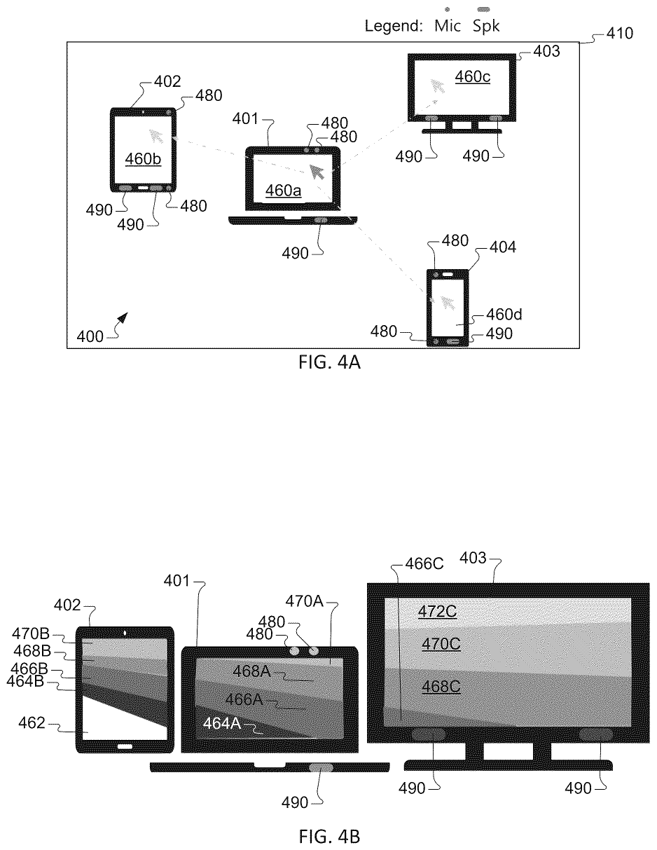

FIGS. 4A and 4B (generally FIG. 4) illustrate examples of a multiple-device localization system 400, 401 according to embodiments of this disclosure. The embodiments of the systems 400, 401 shown in FIGS. 4A and 4B are for illustration only, and other embodiments could be used without departing from the scope of this disclosure.

As shown in FIG. 4A, the multiple-device localization system 400 includes laptop computer 401, a tablet computer 402, a television 403, and a smartphone 404 located within a three-dimensional environment 410. Each of these electronic devices 401-404 includes a display 460 and a speaker 490, and some of these devices 401, 402, 404 include one or more microphones 480.

In this disclosure, Extend Experience refers to a use case in which the multiple-device localization system 400 extends a screen of one device to multiple displays of the devices 401-404. For example, screen of the laptop computer 401 can be extended to one or more among the displays 460a-460d of the devices 401-404. One device among the multiple-device localization system 400 can control the screen and contents in the other devices. In the example shown, a dark-shaded cursor shown on the display 460a controls a lightly shaded cursor shown on the displays 460b-460d of the other devices 402-402. In another example, the smartphone 404 can control the other devices 401-403.

The VMHD app includes a feature that enables distributed speakers to automatically determine their relative locations for speaker configuration, without an addition sensor (such as a camera-LiDAR scanner). More particularly, the multiple-device localization system 400 performs operations that automatically determine relative locations of the first speaker in the laptop 401, the second and third speakers in the tablet computer 402, the fourth and fifth speakers in the television 403, and the sixth speaker in the smartphone 404.

As shown in FIG. 4B, the Extend Experience use case utilizes an inter-device localization technology such that the multiple-device localization system 401 extends a screen of one device to multiple displays of the devices 401-403. In this example, localization technology can enable these devices 401-403 to automatically self-organize the relative locations of the screens. This desirable feature avoids the need for manual arrangement the relative locations of the displays—which can be painstaking and has to be redone each time we connect to a different set of screens or if the screen locations are moved. In this example, the user interface of the application includes six areas 462, 464, 466, 468, 470, and 472 arranged in a slanted vertical stack. The bottom of the user interface includes a first area 462, which is shown on the display of the tablet 402. The user interface includes a second area 464 that is split into a sub-area 464b on the tablet and a remining sub-area on the display of the laptop 401. The user interface includes a third, further, and fifth areas 466, 468, 470 that are each split into a set of three {466A, 466B, 466C}, {468A, 468B, 468C}, {470A, 470B, 470C} sub-areas on the tablet, laptop, and television, respectively. The top of the user interface includes a sixth area 472, which is shown on the display of the television 403.

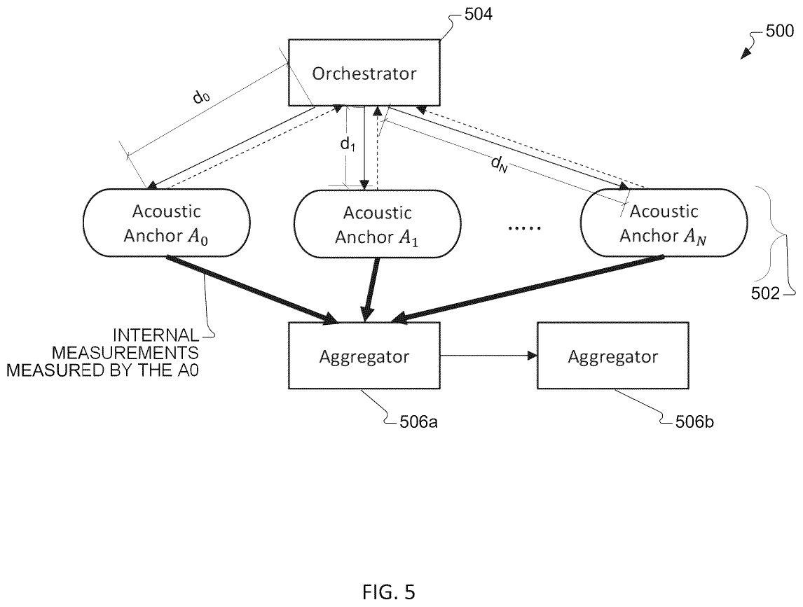

FIG. 5 illustrates a block diagram of an automatic acoustic localization system 500 implementing virtual mapping for multiple heterogeneous devices according to embodiments of this disclosure. The embodiment of the system 500 shown in FIG. 5 is for illustration only, and other embodiments could be used without departing from the scope of this disclosure. The system 500 of FIG. 5 can be the same as or similar to the network configuration 100 of FIG. 1 or the system 400 of FIG. 4.

The system 500 includes a set of acoustic anchors {A₀, A₁, . . . A_{N}} 502, an orchestrator 504, and one or more aggregators 506. An acoustic anchor is an electronic device including a pairing of a speaker and a microphone to transmit and receive modulated acoustic signals. Among the set of acoustic anchors 502, a first acoustic anchor A₀, second acoustic anchor A₁, through N^{th} acoustic anchor A_{N}, each can have the same or similar structure as the electronic device 101 of FIG. 1.

The orchestrator 504 schedules the order of transmitting acoustic signals among the set of acoustic anchors 502. The orchestrator 504 controls the set of acoustic anchors 502 to perform transmitting acoustic signals at a specified time that the orchestrator determines for each acoustic anchor.

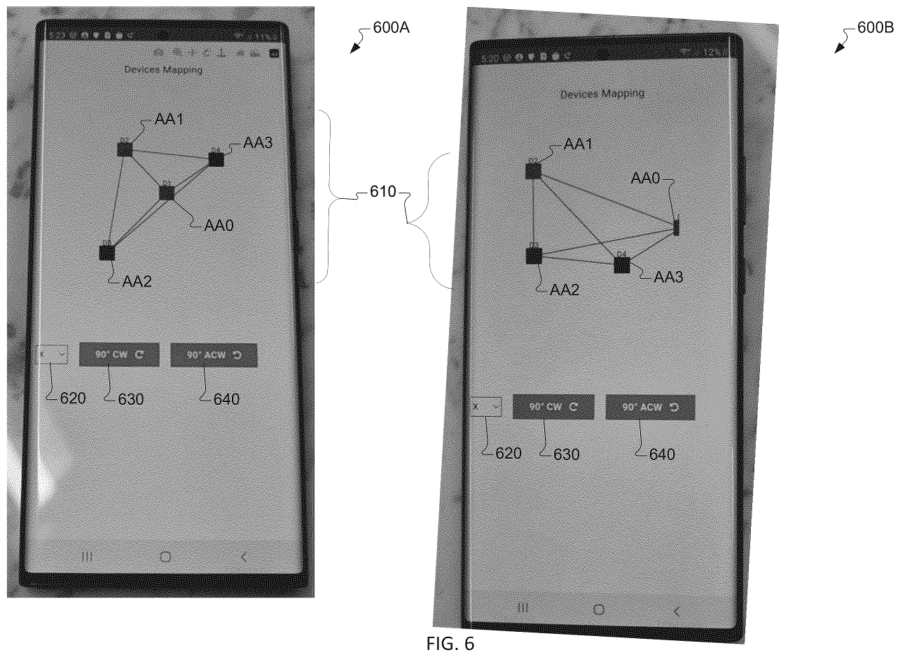

In some embodiments, the aggregators 506 include a first aggregator 506a coupled to a second aggregator 506b. The aggregator 506 aggregates the distributed knowledge from each acoustic anchor and performs global optimization to achieve the optimal geometry structure for the set of acoustic anchors 502. The aggregator 506 provides a user interface (UI) Interactor (shown in FIG. 6) that can visualize the acoustic anchors in the virtual reality and allows users to rotate the whole structure to match the locations in the real.

In some embodiments, the acoustic anchor, orchestrator, and aggregator can be virtual entities (for example, software), which are defined separately in this disclosure for the ease of explanation and generality. In some embodiments, some or all of among the acoustic anchor, orchestrator, and aggregator, may be a part of the same hardware device, without loss of generality. For example, the orchestrator 504 can be one of the acoustic anchors among the set of acoustic anchors 502. As another example, the orchestrator 504 can be the same as or similar to the server 106 of FIG. 1. As a further example, the aggregator 506 can be any electronic device or platform that has a connection to all acoustic anchors among the set of acoustic anchors 502. The aggregator 506 can be a computing node in the local area network together with all acoustic anchors or can be a cloud service accessed via the Internet. The aggregator 506 can also be included within the same hardware device as the orchestrator, or can also be one of the anchor devices themselves.

The system 500 supports a use case for multiple-device localization for Virtual Reality (VR) applications and/or for Augmented Reality (AR) applications. For ease of explanation, this disclosure includes a description of the system 500 that may focus on such device localization for VR/AR applications. However, it is understood that embodiments of this disclosure can be used for other use cases as described herein. Therefore, the application domain (such as a use case) of the embodiments of this disclosure should not be construed as a limitation of the scope of this disclosure.

The system 500 applies acoustic sensing as a fundamental technology to measure the pairwise distance {d₀, d₁, . . . d_{N}} of acoustic anchors {A₀, A₁, . . . A_{N}} and map the position of acoustic anchors into VR/AR. The system 500 executes a method that does not require a user to hold a device to scan the 3D environment to capture (for example, detect) the acoustic anchors, given that the method automatically determines relative positions of the set of acoustic anchors 502. In embodiments of that include the function of receiving user input through the UI interactor of FIG. 6, the method includes only a little involvement of a user.

Due to the increasing popularity of voice assistance service, more and more Internet of Things (IoT) devices are equipped with at least a pairing of a speaker and a microphone to interact with users, and as a result, audio sensors are inexpensive and ubiquitous. These trends promote efforts to build up the new system 500 with novel algorithms on utilizing the presence of acoustic sensors. In the system 500, the centimeter accuracy of acoustic sensing enables accurate geometry reconstruction of distributed devices. In comparison, Use of WiFi and UWB technology to measure pairwise distance has an inferior accuracy that cannot provide stable geometry reconstruction of distributed devices. The localization methods that use WiFi and ultrawide band (UWB) technologies cannot perform at centimeter accuracy and as a result cannot provide stable geometry reconstruction.

FIG. 6 illustrates a user interface (UI) interactor 600 according to embodiments of this disclosure. The embodiment of the UI interactor 600 shown in FIG. 6 is for illustration only, and other embodiments could be used without departing from the scope of this disclosure. In this example, a smartphone implements the UI interactor 600 by displaying a distributed acoustic anchor devices {AA₀, AA₁, AA₂, AA₃} mapped in a geometric reconstruction 610 that is in a first rotational orientation, shown in UI interactor 600A. The distributed acoustic anchor devices {AA₀, AA₁, AA₂, AA₃} in a virtual space represents the set of acoustic anchors 502 in FIG. 5 in a physical space. The geometric reconstruction 610 is a spatial structure in the virtual space and maps the pairwise distances of the set of acoustic anchors 502 in FIG. 5 in the physical space.

The UI interactor 600 receives user input for changing rotational orientation of the geometric reconstruction 610. For example, the user input can include a selection of an axis of rotation 620 from among from a drop-down menu of orthogonal axes (x, y, and z). The user input can include a selection of a direction of rotation from by touch to a clockwise button 630 or an anti-clockwise button 640, which rotates the geometric reconstruction 610 a number of units of angle measurement about the selected axis of rotation in the selected direction (for example, 90 degrees anti-clockwise about the x-axis). The user may continue controlling the UI interactor 600 to change the rotational orientation until the user selects a correct rotational orientation of the geometric reconstruction 610 to be a map of the locations of the set of acoustic anchors 502 in FIG. 5 in the physical space, as shown in UI interactor 600B.

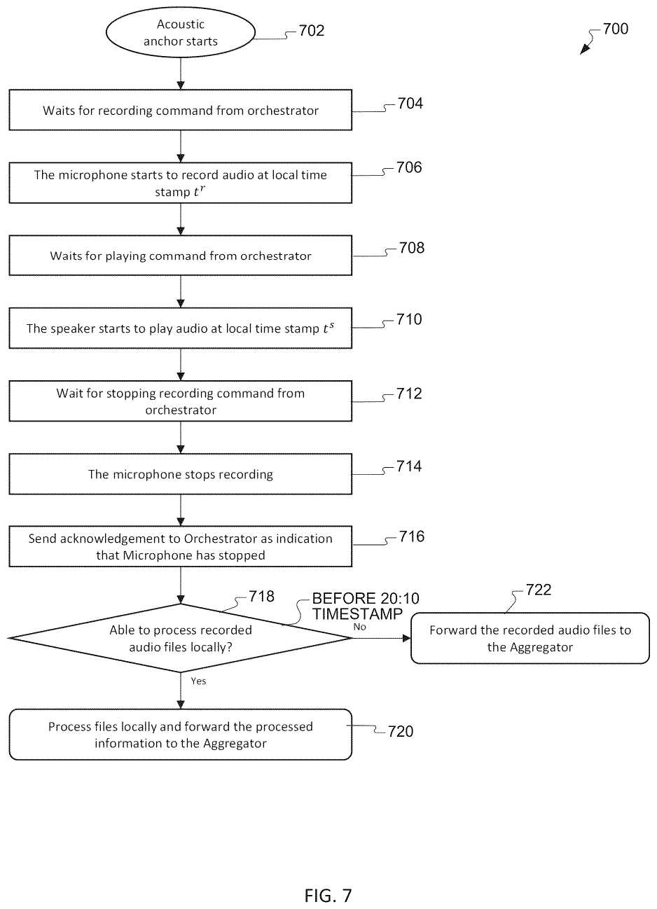

FIG. 7 illustrates a method 700 for operating an acoustic anchor in accordance with an embodiment of this disclosure. The embodiment of the method 700 shown in FIG. 7 is for illustration only, and other embodiments could be used without departing from the scope of this disclosure. The method 700 is implemented by an electronic device that includes both a speaker and microphone, such as the electronic device 101 of FIG. 1, the UE 300 of FIG. 3, the electronic devices 401-402, 404 of FIG. 4, or any one among the set of acoustic anchors 502 of FIG. 5. More particularly, the method 500 could be performed by a processor 120 of the electronic device executing the VMHD app among the application 147. For ease of explanation, the method 700 is described as being performed by the processor 340 in the UE 300 of FIG. 3 executing operations of the Acoustic Anchor A₀ of FIG. 5.

The method 700 describes functions that an acoustic anchor performs interacting with the orchestrator 504 and the aggregator 506a. The acoustic anchor is the target device mapped into VR/XR. A pairing of a speaker and a microphone are included within each acoustic anchor to enable full functionalities of the acoustic anchor. Any device satisfying the condition of including both a speaker and a microphone can be considered as the acoustic anchor, for example a mobile phone, a laptop, a smart watch, a television with support of voice control, a refrigerator supporting voice assistant, and the like. Thus, most of available custom electronics and appliances can be mapped to the VR/XR at home.

At block 702, the processor 340 starts the acoustic anchor. The acoustic anchor initiates the process, which initiation includes opening a port to receive a command from outsource (namely, the orchestrator).

At block 704, the processor 340 waits to receive a recording command from the orchestrator. More particularly, the acoustic anchor waits until the port receives, from the orchestrator, a first command to start recording the audio signals. In this disclosure, the first command from the orchestrator is also referred to as a recording command. The recording command (first command) is configured to trigger the acoustic anchor A₀ send an acknowledgement to the orchestrator 504 to indicate that the identification of the acoustic anchor the received the first command.

At local timestamp t^{r} in block 706, the processor 340 enables the microphone to perform audio recording and to continue recording the audio. The microphone starts to record audio at local time stamp t^{r}. That is, the acoustic anchor starts recording acoustic signals based on the recording command received from the orchestrator. In some embodiments, the acoustic anchor A0 is configured to transmit an acknowledgement to the orchestrator 504 to indicate that the microphone within the acoustic anchor has started recording successfully. In some embodiments, the acoustic anchor A0 is configured to transmit a negative acknowledgement if the microphone within the acoustic anchor failed to start recording, or if the device (for example, television 403 of FIG. 4) does not include a microphone.

At block 708, the processor 340 waits to receive a playing command from orchestrator. More particularly, the acoustic anchor waits until the port receives, from the orchestrator, a second command to start playing the audio symbols.

At block 710, the processor 340 enables the acoustic anchor to start playing audio symbol X through its speaker at local timestamp t^{s}. The speaker starts to play audio at local time stamp t^{s}. More particularly, the acoustic anchor starts playing predefined acoustic symbols X. The acoustic anchor stops playing audio through its speaker after the duration of the predefined audio symbol X elapses.

At block 712, the processor 340 waits to receive a stop recording command from the orchestrator. In this disclosure, a stop recording command is also referred to as a third command from the orchestrator. The acoustic anchor waits until the port receives, from the orchestrator, a third command to stop recording the audio signals.

At block 714, the microphone stops recording. At block 716, the processor 340 sends an acknowledgement to the orchestrator as an indication that the microphone stopped. At block 718, the processor 340 determines whether the acoustic anchor A₀ is able to process recorded audio files locally.

At block 720, the acoustic anchor has the capability to process the recording audio files locally. Based on a determination that the processor 340 is able to process recorded audio files locally, the acoustic anchor A0 processes files locally and forwards the processed information to the aggregator.

Alternatively at block 722, based on a determination that the acoustic anchor A0 is not able to process recorded audio files locally, the processor 340 forwards the recorded audio files to the Aggregator. More particularly, the processor 340 performs preprocessing on the locally recorded audio files, and then sends the preprocessed audio files to the aggregator.

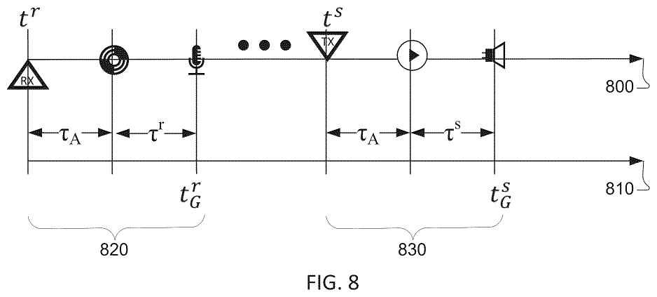

FIG. 8 illustrates an audio recording timestamp model of an acoustic anchor to play and record audio according to embodiments of this disclosure. The embodiments of the timelines 800 and 810 shown in FIG. 8 are for illustration only, and other embodiments could be used without departing from the scope of this disclosure.

In the timestamp model of FIG. 8 includes a local timeline 800 of an acoustic anchor relative to a global reference timeline 810. The anchor device also measures, based on a command from the orchestrator, when the anchor device transmits (via the speaker) a signal t^{s}, and when the anchor device receives (via microphone) a particular signal t_{G}. The acoustic anchor stores the local timestamps of when the acoustic anchor, itself, starts the recording and playing of the audio. However, these measured local timestamps are different from the exact time to operate the audio samples.

The VMHD app defines an audio recording time model 820, within which the

$${t}_{G}^{r}$$

is defined as the exact time (in a global reference clock) of a first sample recorded by the acoustic anchor. What the acoustic anchor measures is the local timestamp t^{r} at which the processor of acoustic anchor, itself, sends a system command to start the microphone recording. The variables

$${t}_{G}^{r}$$

and t^{r} can be related as expressed in Equation 1, where τ^{r} represents the random recording latency due to buffering delay, OS delay, group delay, ADC cost, etc. The random recording latency τ^{r} is a random value every time the acoustic anchor starts a new recording. The term τ_{A} represents the clock drift of local clock of the acoustic anchor to the global clock. The local clock drift τ_{A} is also a random value picked up at a random time. In all, the random difference between

$${t}_{G}^{r}$$

and t^{r} can be significant and outside of the control of common systems.

$${t}_{G}^{r} = {t}^{r} + {τ}^{r} + {τ}_{A} \qquad ( 1 )$$

The VMHD app defines an audio playing time model 830, within which the

$${t}_{G}^{s}$$

is defined as the exact time (in a global reference clock) of the start of transmission of the signal from the speaker by the acoustic anchor. What the acoustic anchor measures is the local timestamp t^{s} at which it sends system command to start the speaker playing. The variables

$${t}_{G}^{s}$$

and t^{s} can be related as expressed in Equation 2, where τ^{s} represents the random recording latency due to buffering delay, OS delay, group delay, DAC cost, etc. Similarly, the random difference between

$${t}_{G}^{s}$$

and t^{s} can be significant and out of the control of common systems.

$${t}_{G}^{s} = {t}^{s} + {τ}^{s} + {τ}_{A} . \qquad ( 2 )$$

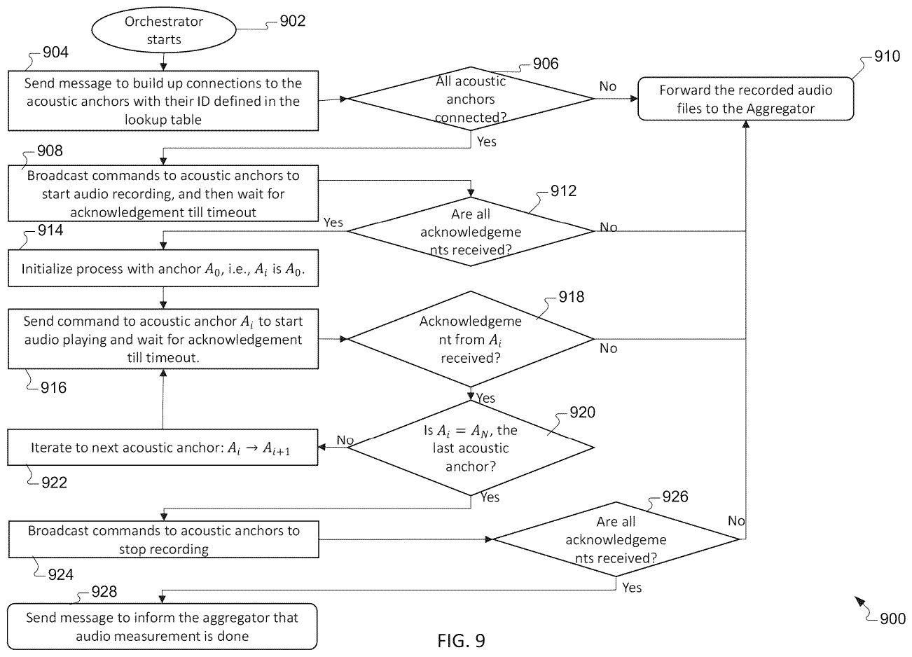

FIG. 9 illustrates a method 900 for operating an orchestrator in accordance with an embodiment of this disclosure. The embodiment of the method 900 shown in FIG. 9 is for illustration only, and other embodiments could be used without departing from the scope of this disclosure. The method 900 is implemented by an electronic device, such as the electronic device 101 or the server 106 of FIG. 1, the UE 300 of FIG. 3, one among the electronic devices 401-404 of FIG. 4, or the orchestrator 504 of FIG. 5. More particularly, the method 900 could be performed by a processor 120 of the electronic device 101 executing the VMHD app among the application 147, particularly executing the functions of the orchestrator 504 of FIG. 5. As another example, the method could be performed by a processor 210 of the server 200 of FIG. 2 executing the functions of the orchestrator 504 of FIG. 5. For ease of explanation, the method 900 is described as being performed by the orchestrator 504 of FIG. 5.

The method 900 describes functions that an orchestrator 504 performs interacting with a set of acoustic anchors 502 and the aggregator 506a. The orchestrator initiates a protocol in which the set of anchors 502 perform audio playing and recording based on an orchestrated schedule. The orchestrator schedules the order of playing sound and the order of recording sound for each acoustic anchor. The scheduling method is coupled with the aggregation algorithm described in this disclosure. The orchestrator 504 can be any electronic device or platform that has a communication connection to all the acoustic anchors in the set of acoustic anchors 502. The orchestrator 504 can be a computing node in a local area network together with all acoustic anchors, or the orchestrator 504 a cloud service that communicates with the set of acoustic anchors 502 via the Internet. The orchestrator 504 performs operations in a method 900 that enables the virtual construction algorithm according to embodiments of this disclosure.

At block 902, the orchestrator 504 starts the method 900. For example, the device on which the orchestrator is installed can start executing the VMHD app.

At block 904, the orchestrator 504 sends messages to establish connections to the set of acoustic anchors 502, and the messages include the IDs of the set of acoustic anchors 502, respectively defined in a lookup table (LUT). For example, the message transmitted by the orchestrator 504, when received by the first acoustic anchor A₀, enables the first acoustic anchor A₀ to communicate with the orchestrator and provides the LUT to the first acoustic anchor A₀.

At block 906, the orchestrator 504 determines whether all among the set of acoustic anchors 502 have established a communication connection to the orchestrator 504. For example, the orchestrator 504 checks the response from acoustic anchors to determine whether all the acoustic anchors are connected well. The method proceeds to block 908 if the connections are good, but otherwise, the method proceeds to block 910 if any one among the set of acoustic anchors 502 has a bad connection.

At block 908, the orchestrator 504 broadcasts commands to the set of acoustic anchors 502 to start audio recording, and then waits to receive an acknowledgement from each of the anchors before a timeout period elapses. This broadcasted recording command (first command) is configured to trigger a processor of an acoustic anchor to: complete the waiting procedure of block 704; switch a microphone of the acoustic anchor to an ON state; and start recording acoustic signals through the microphone. The method proceeds to block 912 based on a determination that the orchestrator 504 received a respective acknowledgement from the N anchors (502), or alternatively based on expiry of the timeout period, whichever occurs earlier.

At block 910, the orchestrator 504 forwards the recorded audio files to the aggregator 506.

At block 912, the orchestrator 504 determines whether itself received acknowledgements from all among the set of acoustic anchors 502, respectively. For example, receipt of the acknowledgements transmitted at block 706 of FIG. 7 can trigger the orchestrator 504 to commence the procedure at block 912. Additionally, the orchestrator 504 checks the respective acknowledgements from N acoustic anchors 502 to determine whether all the acoustic anchors have started recording successfully. The method 900 proceeds to block 914 if all the N acoustic anchors 502 are in a recording state (microphone is on), but otherwise, the method proceeds to block 910. For example, if the orchestrator 504 receives a negative acknowledgement identifying a particular device (for example, television 403 of FIG. 4), then the orchestrator 504 determines that not all the acoustic anchors have started recording audio, and the method proceeds to block 910.

Blocks 914 to 922 include a sub-process for controlling a respective acoustic anchor to play an audio symbol X at specified play-start time. At block 914, the orchestrator 502 initiates acoustic anchors Aᵢ for i=1 to N. The procedure at block 914 is iterative, which can be performed N times as the orchestrator 502 initiates one acoustic anchor at a time. More particularly, orchestrator 502 performs an initialization process with a respective acoustic anchor Aᵢ (for example, Aᵢ as A₀).

At block 916, the orchestrator 502 sends a command (second command) to acoustic anchor Aᵢ to start playing audio, and then the orchestrator 502 waits to receive an acknowledgement from the respective acoustic anchor Aᵢ till timeout (for example, till expiry of a timeout period). The acknowledgement from the anchor Aᵢ indicates that the processor of the acoustic anchor Aᵢ has been triggered by receipt of the second command to start playing the audio symbol X through its speaker, or that the speaker has completed playing the audio symbol X.

At block 918, the orchestrator 502 checks or determines whether the acknowledgement from the respective acoustic anchor Aᵢ is received. The method proceeds to block 920 if the anchor Aᵢ finalized the playing audio well. Else, the method proceeds to block 910 based on a determination that the orchestrator 502 did not receive an acknowledgment from the anchor Aᵢ.

At block 920, the orchestrator 502 checks whether the respective acoustic anchor Aᵢ is the last acoustic anchor to play the audio symbol X. The method proceeds to block 922 if the anchor Aᵢ is the not the last anchor to be processed through the sub-process 914-922. At block 922, the orchestrator 502 increments the index i (Aᵢ→Aᵢ₊₁) in order to iterate to the next acoustic anchor. At block 922, the orchestrator 502 sets the next communicating acoustic anchor Aᵢ₊₁.

The method proceeds from block 920 to block 924 if the anchor Aᵢ is the last anchor among the set of N anchors 504 to be processed through the sub-process 914-922, for example, if the set of N anchors 504 includes any acoustic anchor that has not been processed through the sub-process 914-922.

At block 924, the orchestrator 502 broadcasts commands (third command) to the set of acoustic anchors 504 to stop audio recording and then wait to receive acknowledgements from each among the set of acoustic anchors 504 till timeout.

At block 926, the orchestrator 502 checks the acknowledgements received from acoustic anchors to determine whether all among the set of acoustic anchors 504 has started recording successfully based on receipt the third command. In some embodiments, the orchestrator 502 determines whether all the recording is off, such as when the orchestrator receives N acknowledgement indicating that each among the set of acoustic anchors 504 completed playing the acoustic symbol and has switched OFF the recording mode. If the one or more of the acoustic anchors has not switched OFF the recording mode, or if acknowledgements are received from fewer than N acoustic anchors 504, then the method proceeds to block 910 at which the orchestrator 502 reports the connection error with the acoustic anchors and stops the process.

At block 928, the orchestrator 502 sends messages to the aggregator 506 to inform the aggregator 506 that the audio measurement stage is complete. The method 900 ends upon completion of the procedure at block 928.

As shown in FIG. 9, the orchestrator manages the audio measurement stage (for example, by performing the method 900) and instructs the acoustic anchors to play the audio and record the sound in the optimal way. With a well-designed management protocol (such as the sub-process 916-922), each acoustic anchor is able to record the audio symbols X emitted from other acoustic anchors without overlapping recordings of each other. In this case, any pair of acoustic anchors may receive (via the microphone) the acoustic symbols emitted from themselves as well the other.

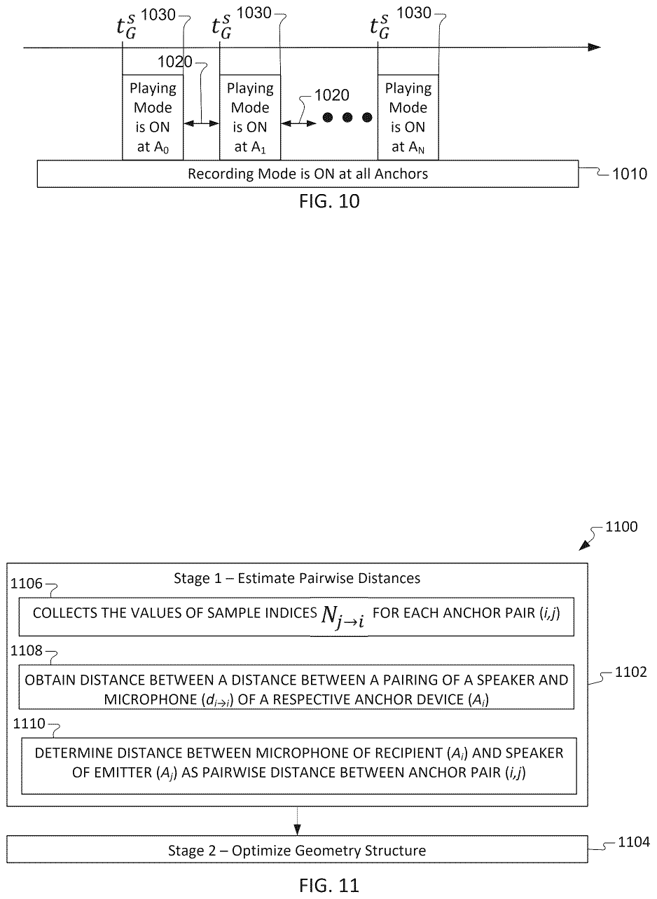

FIG. 10 illustrates an example of the management protocol in which the orchestrator 502 requests all the anchors to start measurement over a common large time window 1010, according to embodiments of this disclosure. The embodiment of the management protocol shown in FIG. 10 is for illustration only, and other embodiments could be used without departing from the scope of this disclosure. Each acoustic anchor generates its own recording of an acoustic waveform from the start of the measurement window 1010 through the end. It may also assign each anchor to transmit its audio signal sequentially within the measurement window 1010 while ensuring there is sufficient time gap 1020 between the end of the audio transmission 1030 of one anchor to the start of the audio transmission from another anchor. This time gap 1020 can include time for the processing delays (for example, accounting for maximum processing delays) associated with the different anchors, the echo in the room, any hardware delays associated with switching on/off of the speaker or microphone, etc. For example, the time gap 1020 can include recording latency τ^{r} associated with a microphone and/or playback latency τ^{s} associated with a speaker of different anchors.

In some embodiments, the orchestrator 502 chooses the transmit signals from each anchor to be one that has good auto-correlation properties such as a strong peak at 0-shift but small value at other non-zero shifts. Such a transmit signal from the anchor can be generated using a Zadoff-Chu sequence.

The transmit signals (such as the predefined symbol X) from all anchors can be identical, in which case a receiver determines the source of the signal based on either the transmit pattern shared by the orchestrator, or using a unique identifier transmitted by the anchor within the transmitted signal to identify that anchor as the source. In another embodiment, the transmit signals from all anchors can be different from each other, and can transmit signals that have good cross-correlation properties. Good cross-correlation properties can include a condition in which the transmit signal from one anchor has very low correlation with the transmit signal from another anchor, for all correlation shifts.

In this disclosure, a pair of acoustic anchors includes: an emitter anchor (Aⱼ) having a speaker that emits a predefined acoustic signal (such symbol X); and a recipient anchor (Aᵢ) that generates an audio recording of an acoustic waveform received by its microphone. Each acoustic anchor is the recipient anchor in N respective pairs of acoustic anchors, such that, the audio recording generated by the recipient anchor (for example, Aᵢ=A₀) represents N acoustic signals respectively transmitted from the set of N acoustic anchors 502 and received by the microphone of the recipient anchor (including when the recipient anchor itself is the emitter anchor (for example, Aⱼ=A₀)). Based on the audio recordings, each recipient anchor Aᵢ also computes an audio sample index N_{j→i} when it receives the start of the audio signal transmitted by anchor Aⱼ. As an example, this computation of the audio sample indices is accomplished by the recipient anchor: having knowledge of the signal transmitted from the emitter anchor Aⱼ; running a cross-correlation function of the audio recording at the recipient anchor Aᵢ with the known transmitted signal from anchor Aⱼ; and identifying the peak sample index of the cross-correlation function as N_{j→i}.

FIG. 11 illustrates an algorithm 1100 performed by the aggregator 506 to integrate the global information of all acoustic anchors to reconstruct the geometry map, according to embodiments of this disclosure. The embodiment of the aggregator algorithm 1100 shown in FIG. 11 is for illustration only, and other embodiments could be used without departing from the scope of this disclosure.

The aggregator algorithm 1100 has two stages 1102 and 1104. In the first stage 1102, the aggregator 506 estimates the accurate pairwise distances between acoustic anchors. In the second stage, aggregator 506 applies the optimization methods to find the best geometry structure that matches the estimated pairwise distances.

To enable pairwise distance estimation the first stage 1102, at block 1106, the aggregator collects the values of N_{j→i} for each anchor pair (i,j) where N_{j→i} represents the sample index in recording of anchor Aᵢ when the recipient anchor Aᵢ receives the start of the audio signal transmitted by the emitter anchor Aⱼ. Using these values, the aggregator 506 can estimate the pairwise distances d_{i→j} between all pairs of anchors (i,j). In one embodiment, the aggregator 506 estimates the pairwise distances based on an assumption that the aggregator 506 is aware of the distances divi ahead of time, which is the distance between the speaker of anchor i and the microphone of anchor i. These distances d_{i→i} can be obtained at block 1108 by the aggregator 506, for example, pre-stored at the aggregator 506 or can be shared to the aggregator by the anchors, along with the values of N_{j→i}.

In one embodiment at block 1110, the aggregator determines the distance between recipient anchor Aᵢ and emitter anchor Aⱼ, which distance can be estimated according to Equation 3, where v is the speed of sound and sr is the sampling rate of the audio recordings.

$${d}_{i \to j} = \frac{1}{2} ( \frac{v}{sr} ( {N}_{i \to j} + {N}_{j \to i} - {N}_{i \to i} - {N}_{j \to j} ) + {d}_{i \to i} + {d}_{j \to j} ) \qquad ( 3 )$$

One example mechanism for calculation of the pairwise distances between anchors is described further below. At the first stage 1102, for ease of exposition, consider the case of two acoustic anchors A₀ and A₁, without loss of generality. Note that these equations can easily be extended to any pairs of anchors Aᵢ and Aⱼ. The first sample emitted by A₀ is at global reference clock timestamp

$${t}_{G}^{{s}_{0}} ,$$

as calculated according to Equation 4. The first sample recorded by the first acoustic anchor A₀ is recorded at global reference clock timestamp

$${t}_{G}^{{r}_{0}} ,$$

as calculated according to Equation 5.

$${t}_{G}^{{s}_{0}} = {t}^{{s}_{0}} + {τ}^{{s}_{0}} + {τ}_{{A}_{0}} \qquad ( 4 )$$

$${t}_{G}^{{r}_{0}} = {t}^{{r}_{0}} + {τ}^{{r}_{0}} + {τ}_{{A}_{0}} \qquad ( 5 )$$

Similarly, the first sample emitted by A₁ is at global reference clock timestamp

$${t}_{G}^{{s}_{1}} ,$$

as calculated according to Equation 6. The first sample recorded by the second acoustic anchor A₁ is recorded at global reference clock timestamp

$${t}_{G}^{{r}_{1}} ,$$

as calculated according to Equation 7. In Equation 3 through Equation 7, the distance between the speaker of anchor A₀ and the microphone of anchor A₁ is denoted as d_{0→1}, the sampling rate of both anchors A₀ and A₁ is denoted as sr, the velocity of acoustic speed is v.

$${t}_{G}^{{s}_{1}} = {t}^{{s}_{1}} + {τ}^{{s}_{1}} + {τ}_{{A}_{1}} \qquad ( 6 )$$

$${t}_{G}^{{r}_{1}} = {t}^{{r}_{1}} + {τ}^{{r}_{1}} + {τ}_{{A}_{1}} \qquad ( 7 )$$

$${t}_{G}^{{s}_{0}} ,$$

When first anchor A₀ emits the first sample at global reference clock timestamp the second anchor A₁ will receive the sample as its N_{0→1}-th sample. The receive global absolute timestamp is expressed according to Equation 8. Then the formulation between the distance and the timestamps is expressed according to Equation 9. In Equation 8 through Equation 9, t^{r}^{₁},

$$\frac{{N}_{0 \to 1}}{sr} ,$$

t^{s}^{₀} are measurable variables while τ^{r}^{₁}, τ_{A}_{₁}, τ^{s}^{₀}, τ_{A}_{₀} are random variables. Thus, the distance d cannot be estimated accurately even though an accurate measurement of the time when the first sample played by A₀ is recorded by A₁ at its N_{0→1}-th sample.

$${t}_{G}^{{r}_{1}} + \frac{{N}_{0 \to 1}}{sr} \qquad ( 8 )$$

$${d}_{0 \to 1} = v ( {t}_{G}^{{r}_{1}} + \frac{{N}_{0 \to 1}}{sr} - {t}_{G}^{{s}_{0}} ) = v ( {t}^{{r}_{1}} + {τ}^{{r}_{1}} + {τ}_{{A}_{1}} + \frac{{N}_{0 \to 1}}{sr} - ( {t}^{{s}_{0}} + {τ}^{{s}_{0}} + {τ}_{{A}_{0}} ) ) \qquad ( 9 )$$

However, apart from the above where anchor A₁ also receives acoustic samples emitted from anchor A₀, three similar acoustic event happen concurrently: (i) A₀ receives acoustic samples from A₁; (ii) A₀ receives acoustic samples from A₀; (iii) A₁ receives acoustic samples from A₁. From these three events, Equations 10, 11, and 12 are three new formulations that can be obtained similar to Equation 9. Here in Equations 10, 11, and 12, the variables d_{1→0}, d_{0→0}, d_{1→1} represent the distance between the speaker of A₁ and the microphone of A₀, the distance between the speaker of A₀ and the microphone of A₀, the distance between the speaker of A₁ and the microphone of A₁ respectively. N_{1→0}, N_{0→0}, N_{1→1} represents the sample index of the first sample emitted by A₁ in the A₀'s recording, the sample index of the first sample emitted by A₀ in the A₀'s recording, the sample index of the first sample emitted by A₁ in the A₁'s recording.

$${d}_{1 \to 0} = v ( {t}^{{r}_{0}} + {τ}^{{r}_{0}} + {τ}_{{A}_{0}} + \frac{{N}_{1 \to 0}}{sr} - ( {t}^{{s}_{1}} + {τ}^{{s}_{1}} + {τ}_{{A}_{1}} ) ) \qquad ( 10 )$$

$${d}_{0 \to 0} = v ( {t}^{{r}_{0}} + {τ}^{{r}_{0}} + {τ}_{{A}_{0}} + \frac{{N}_{0 \to 0}}{sr} - ( {t}^{{s}_{0}} + {τ}^{{s}_{0}} + {τ}_{{A}_{0}} ) ) \qquad ( 11 )$$

$${d}_{1 \to 1} = v ( {t}^{{r}_{1}} + {τ}^{{r}_{1}} + {τ}_{{A}_{1}} + \frac{{N}_{1 \to 1}}{sr} - ( {t}^{{s}_{1}} + {τ}^{{s}_{1}} + {τ}_{{A}_{1}} ) ) \qquad ( 12 )$$

These formulations in Equations 10, 11, and 12 have common random variables. These variables can be reduced (for example, eliminated or canceled out) with a linear operation in which the sum of Equations 11 and 12 is subtracted from the sum of Equations 9 and 10, as expressed in Equation 13. Then, Equations 14 is the result of Equation 13. Note that Equation 14 does not include the random variables due to the jitter of audio playing and recording and the random clock drifts. Equation 14 also eliminates the requirement to measure the system time at which the audio recording/transmission was started at each of the anchors in their local clocks, i.e., τ^{r}^{₀}, τ^{s}^{₀}, τ^{r}^{₁}, τ^{s}^{₁}.

$$( 9 ) + ( 10 ) - ( 11 ) - ( 12 ) \qquad ( 13 )$$

$${d}_{0 \to 1} + {d}_{1 \to 0} - {d}_{0 \to 0} - {d}_{1 \to 1} = \frac{v}{sr} ( {N}_{0 \to 1} + {N}_{1 \to 0} - {N}_{0 \to 0} - {N}_{1 \to 1} ) \qquad ( 14 )$$

To obtain the distance d_{0→1} between A₀ and A₁, we may use the fact that d_{0→1}=d_{1→0}, which holds for most devices. d_{0→0} and d_{1→1} are constant since they refer to the fixed distance between the microphone and the speaker of themselves. They can be measured as the device properties. The formulation to estimate the distance is Equation 15, which only requires the measurements of the first arrival sample of each speaker and microphone pair, N_{0→1}, N_{1→0}, N_{0→0}, N_{1→1}. These are measurable values based on the design of the emitting audio symbols.

$${d}_{0 \to 1} = \frac{1}{2} ( \frac{v}{sr} ( {N}_{0 \to 1} + {N}_{1 \to 0} - {N}_{0 \to 0} - {N}_{1 \to 1} ) + {d}_{0 \to 0} + {d}_{1 \to 1} ) \qquad ( 15 )$$

Referring back to block 1106 at which the aggregator 506 estimating N_{j→i} for each anchor pair among the set of anchor s 502. To calculate the values of N_{j→i}, in one embodiment, the cross correlation may be applied between the predefined transmit audio symbols X and received audio recording xᵢ on the acoustic anchor Aᵢ, i.e., c=f(xᵢ,X) where f( ) represents as a cross correlation function. In the case where the audio transmission signal X is same for all anchors, there may be n correlation peaks in c since all n acoustic anchors play the audio symbols in the order instructed by the orchestrator. The j-th peak in c represents the value of N_{j→i}. With all the estimation of N_{j→i}, the pair distance between acoustic anchors can be inferred via Equation 15.

In one embodiment, f( ) can also work as the FMCW demodulation algorithm when X is a FMCW symbol. It returns peaks in the frequency domain which can be transformed into time domain peaks linearly. These can then be used to compute d_{i→j} values. With the measured values of d_{i→j} for all anchor pairs (i,j), the aggregator 506 can perform reconstruction of the devices locations as described below in stage 2.

The aggregator implements a Multidimensional Scaling (MDS) and UI Interactor to optimize geometry structure at block 1104. Particularly, MDS is a statistical method that simplifies complex data sets by representing relationships between variables in a spatial model. It is used to reduce the complexity of high-dimensional data so that it is easier to interpret. MDS maps proximity data between objects into distances between points in a multidimensional space. The goal is to find a lower dimensional representation of a dissimilarity matrix while preserving pairwise distances as much as possible. It is a good fit for spatial construction problem being considered here. With distance pair d_{i→j}, we can build up the adjacency matrix D with D(i,j)=d_{i→j}. Given the adjacency matrix and the target output dimension number as 2 or 3, the 2D or 3D coordinates of each target can be estimated.

Although result of using MDS can show the correct spatial structure of the target devices, the spatial structure still may have rotational ambiguity. Whenever a structure rotates itself in the spatial space, the adjacent matrix D remains the same. Therefore, MDS may not be able to determine the exact orientation of the spatial structure of these target devices. Thus, in one embodiment, the aggregator 506 includes a user interface (UI) interactor in the system, as described herein with FIG. 6. UI interactor first visualizes the structure of the target devices on the screen, based on the result of the MDS. Then, the UI interactor allows users to rotate the whole structure to match the correct orientation as they see it. This is a one-time calibration for the user to perform. It is easy or intuitive for users to operate on the screen and complete this task. Note that the user operates the whole structure instead of piece-by-piece, so that the solution is scalable and more user friendly.

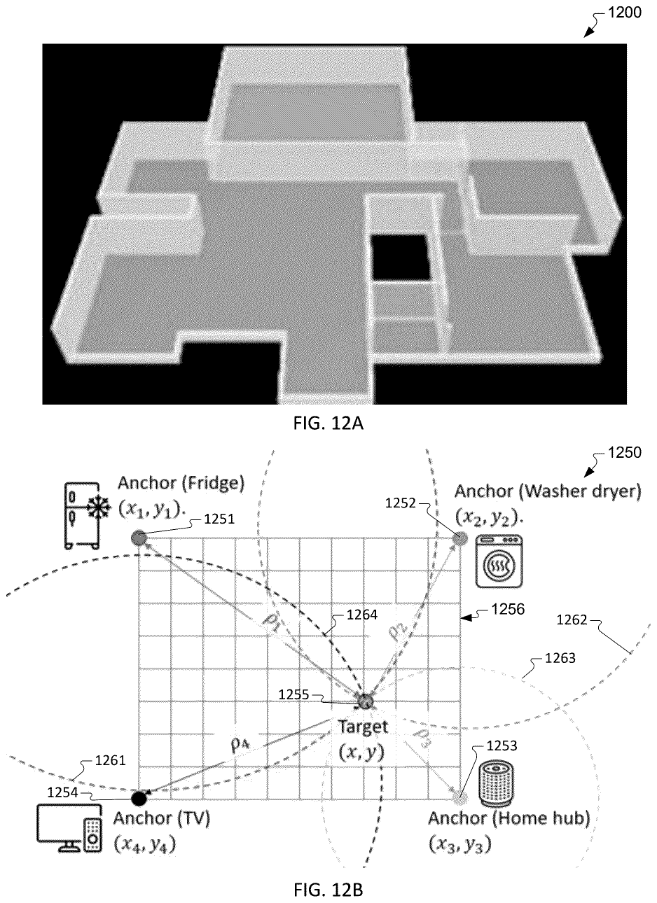

FIGS. 12A and 12B together illustrate a self-localization system to automatically obtain location of smart home devices, according to embodiments of this disclosure. The self-localization system includes a virtual map of a physical environment, and a set of acoustic anchor devices implementing a mobile target localization (via trilateration) algorithm, according to embodiments of this disclosure.

FIG. 12A illustrates a home layout 1200 available at a smart home application or platform that can be accessed by the VMHD app 147, 363 according to embodiments of this disclosure. The embodiment of the home layout 1200 shown in FIG. 12A is for illustration only, and other embodiments could be used without departing from the scope of this disclosure. The home layout 1200 can be a virtual representation of a physical environment, such as the physical three-dimensional environment 410 of FIG. 4. For example, the home layout 1200 be a 3D model generated by a visual camera and/or LiDAR scanner, and the smart home application or platform (similar to the application 147 of FIG. 1) such as a robot vacuum app or platform. In some embodiments, the VMHD app can obtain the home layout 1200 from the robot vacuum app, which provides knowledge about locations of smart home devices, respectively, to the VMHD app.

FIG. 12B illustrates a mobile target localization algorithm 1250 implemented using a set of acoustic anchor devices, according to embodiments of this disclosure. The embodiments of the mobile target localization algorithm shown in FIG. 12B is for illustration only, and other embodiments could be used without departing from the scope of this disclosure. The mobile target localization (via trilateration) algorithm can be included within the VMHD app 147, 363. This example shown in FIG. 12B demonstrates that this disclosure is not limited to localization of devices for AR/VR applications, and that other use cases are described herein.

The technology of this disclosure can be used to localize any devices that each includes at least one speaker and at least one microphone. Such devices may include one or more of: Smart watches, Wireless or smart earbuds, smart refrigerators, smart laundry units (including smart washer and smart dryer), smart microwaves or cooktops, Smart TVs, Tablets, Laptops, and Smart phones, etc. In one embodiment, the mobile target localization algorithm 1250 provides localization technology that can be used to self-localize different types of “fixed” devices in a house, such as a smart fridge 1251, a Laundry Unit 1252, smart speaker 1253, or Smart TV 1254 etc. In some embodiments, these stationary smart devices may serve as anchor devices to provide localization/proximity services for other mobile target devices 1255 like the Smart phones, Vacuum robots, etc., in a smart home as depicted in FIG. 12B. For enabling such self-localization, the location of the anchors 1251-1254 is measured with high accuracy (for example, accuracy that is greater than or equivalent to a threshold level of accuracy such as centimeter level accuracy), which locations can be obtained using the embodiments of this disclosure including the VMHD app.

In one embodiment, a smart home application or platform may have knowledge of the map or layout 1200 of a smart home. Such embodiment implements a mobile target localization (via trilateration) using anchor devices 1251-1254 having locations obtained from the home layout 1200 of FIG. 12A. Such layout information may be obtained, for example, using user inputs to the smart home app, or through information acquired by a separate device, such as a Vacuum robot. In some embodiments, it may be desirable to automatically identify locations of different smart home devices (e.g. TV, fridge, washer/dryer) on this map/layout 1200. It can be a painstaking and undesirable user experience to require a user to place (for example, drag and drop user input) these devices within the map/layout 1200 via an interactive service. As a solution, the VMHD app includes self-localization methods described herein, the relative locations of smart home devices may be obtained automatically, and these may be mapped to the home map/layout 1200 automatically via a matching algorithm. If any device location changes, its location on the map can also be updated automatically without human intervention. This automatic matching algorithm can be used as an alternative or as a replacement of the minimal interaction (e.g., user input) from the user that the UI Integrator 600 requests.

Within the mobile target localization algorithm 1250, the automatic matching algorithm can map the home layout 1200 of FIG. 12A into the coordinate system 1256. The coordinate system 1256 is shown with two dimensions (x-axis and y-axis), but it is understood that the coordinate system 1256 can have a third dimension (z axis). That is, the location of each stationary anchor 1251-1254 in the coordinate system 1256 (such as (x1, y1) location of fridge 1251) is mapped to a location in the home layout 1200. The respective pairwise distances ρ1, ρ2, ρ3, and ρ4 from the target device 1205 to each respective anchor 1251-1254 is determined by the aggregator 506. The location of the target device 1255 can be determined by an intersection of arcs 1261-1264 respectively centered around each respective anchor 1251-1254.

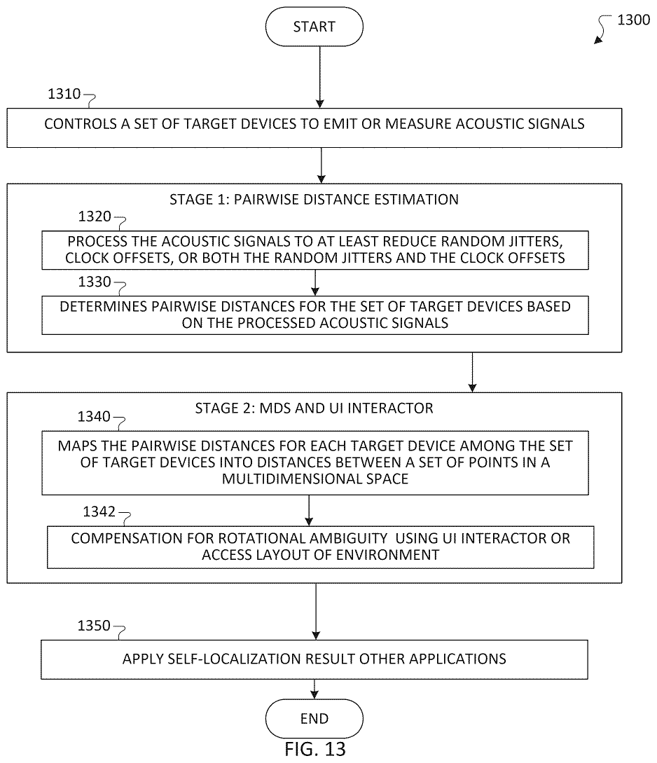

FIG. 13 illustrates a method 1300 for accurate virtual mapping for distributed heterogeneous devices with speaker and microphone in accordance with an embodiment of this disclosure. The embodiment of the method 1300 shown in FIG. 13 is for illustration only, and other embodiments could be used without departing from the scope of this disclosure. The method 1300 is implemented by a system, such as the network 100 of FIG. 1, the system of FIG. 5, or the system 1250 in FIG. 12B. In some embodiments, method 1300 is implemented by an electronic device that functions as the orchestrator 502 to control a set of anchor devices 504, such as the electronic device 101 of FIG. 1, the server 200 of FIG. 2, or the orchestrator 502 of FIG. 5. More particularly, the method 1300 could be performed by a processor 120 of the electronic device 101 executing the FMHD app within among the application(s) 147. For ease of explanation, the method 1300 is described as being performed by the processor 120.

In block 1310, the processor 120 controls a set of target devices to emit or measure acoustic signals. Each target device has a capability of emitting and receiving acoustic signals. The procedure at block 1310 includes the method 900 of FIG. 9 in which the orchestrator controls anchors to transmit at the speaker and receive at the microphone.

In some embodiments, the procedure of measuring acoustic signals at block 1310 includes the processor 120 controlling the set of target devices to perform cross-correlation between expected signal to be received and actual signal received, which is how each anchor extracts (for example, calculates) the value of N_{j→i}.

The procedure at blocks 1320 through 1330 can be the same as or similar to the procedure at the first stage 1102 of FIG. 11. At block 1320, the processor 120 processes the acoustic signals to at least reduce random jitters, clock offsets, or both the random jitters and the clock offsets. In some embodiments, reducing includes cancelling out, eliminating, or reducing the random jitters and/or clock offsets to a negligible amount, as described herein with creating the sub-algorithm expressed as Equation 14. For example, the aggregator uses the time-sample models 820 and 830 of FIG. 8 to compensate for clock offsets TA and to compensate for random jitters (random variables) τⁱ and τ^{s}.

At block 1330, the processor 120 determines pairwise distances for the set of target devices based on the processed acoustic signals. More particularly, the pairwise distances can be determined using Equation 15 described herein, which compensates for distance between anchor's spacing between its own speaker and microphone as described in Equation 11. For the example in which the orchestrator 504 is included within one acoustic anchor among the set of anchors 504, its pairwise distances {d₀, d₁, . . . d_{N}} are shown in FIG. 5. For example, as shown in FIG. 12B, the pairwise distances for the target device 1255 includes the distances ρ1 through ρ4 from the location of the target device to the respective locations of each fixed anchor 1251-1254.

At block 1340, the processor 120 maps the pairwise distances for each target device among the set of target devices into distances between a set of points in a multidimensional space. More particularly, the processor 120 determines a geometry from the pairwise distances received, and in the geometry, the distances between the set of points are mapped as shown in the geometric spatial structure 610 in the UI Interactor 600. In another example as shown in FIG. 12B, the coordinates of the locations of the set of devices 1251-1255 in the coordinate system 1256 are examples of a set of points in a multidimensional space. The pairwise distances between the locations of the anchors in the smart home in the physical space are respectively mapped to the distances between the points that represent the virtual locations of the devices 1251-1255 in the coordinate system 1256. Similarly, the pairwise distances between the devices 401-404 shown in the environment 410 in FIG. 4 are mapped into a virtual multidimensional space (such as coordinate system 1256) as distances between a set of points, where the set of points represents the set of anchor devices.

At block 1342, processor 120 compensates for rotational ambiguity in the set of points in the multidimensional space (i.e., the geometric spatial structure 610) by determining a correct orientation based on user input to the UI Interactor 600. For example, the geometric spatial structure in the virtual world shown at 600A might be a mirror-image reflection of the correct orientation in the physical world. In some embodiments, the UI Interactor 600 presents two possible spatial structures (for example, two rotational orientations shown in 600A and 600B that are reflections of each other), and prompts that user to select one correct orientation. In other embodiments, the UI interactor 600 presents the geometric spatial structure 610 and prompts the user to input an axis of rotation, direction of rotation, and angle of rotation using button 620, 630, 640. In some embodiments, the processor 120 does not use user input, but instead automatically communicates with a smart home app to access a layout 1200 to retrieve locations of the fixed anchor devices 1251-1254. The processor 120 determines the correct orientation based on the location information that matches the layout 1200.

In some embodiments of the method 1300, the processor 120 can generate a geometric representation that at least partially matches respective positions of the target devices among the set of target devices. The processor 120 can determine at least one orientation of the geometric representation based on pairwise distances for the set of target devices.

In some embodiments, the processor 120 can select a correct orientation from among the at least one orientation of the geometric representation, based on at least one of: a user selection received via a user interface (UI) interactor that displays each from among the at least one orientation of the geometric representation; or layout information received from an external device, the layout information including respective positions of the set of target devices mapped to a layout of a physical environment.

At block 1350, the processor can apply the self-localization result (such as the correct orientation of the geometric spatial structure 610) to other applications, including to Extend Experience use cases, VR/AR applications, VR/XR application, and the multi-display user interface of FIG. 4B.

In some embodiments of block 1310, to control the set of target devices to measure acoustic signals, the processor 120 can: control a microphone within a respective target device among the set of target devices to start to record acoustic signals at a specified listen start time; and control the microphone within the respective target device to stop recording acoustic signals at a specified listen stop time.

In some embodiments, the procedure of block 916 can be used to control the set of target devices to emit acoustic signals, and the processor 120 can iteratively control a speaker within a respective target device among the set of target devices to start to emit a predefined acoustic signal at a specified play-start time until everyone among the set of target devices has emitted the predefined acoustic signal at different play-start times.

In some embodiments, the processor 120 can use the procedure of block 1106 to collect measurements of the acoustic signals from a respective target device among the set of target devices, including at least one of: a recording of an acoustic waveform received by a microphone of the respective target device; an indication of sample indices, within the acoustic waveform that the target device recorded and sampled, at which the respective target device detected a beginning of a predefined acoustic signal emitted from each among the set of target devices; an indication of a distance between a pairing of a speaker and microphone of the respective target device; an indication of a sampling rate of the acoustic waveform that the target device recorded and sampled; or an indication of a start time of the recoding of the acoustic signal by a local clock of the respective target device. Further, to determine a subset among the pairwise distances for the set of target devices, the processor 120 can determine, based on the collected measurements of the acoustic signals from the respective target device, pairwise distances between the respective target device and each of the others among the set of target devices. Here, for example, the others among the set of target devices can refer to those within the set of target devices except the respective target device. To determine the subset as the pairwise distances between the respective target device and each of the others among the set of target devices, the processor 120 can be further configured to reduce an impact of clock offsets and processing delays of the collected measurements, including to at least one of: detect, within the recording of the acoustic waveform collected from the respective target device, a beginning of a predefined acoustic signal emitted from each among the set of target devices and assign sample indices to the detected beginnings, respectively; determine the subset as the pairwise distance as a function of the sample indices assigned to the detected beginnings, the indication of the sampling rate of the acoustic waveform, the indication of the distance between the pairing of the speaker and microphone of the respective target device, another indication of a distance between a pairing of a speaker and microphone of the other among the set of target devices, and the speed of sound; or determine both a clock drift of the local clock of the respective target device with respect to a global reference clock, and based on the clock drift, a timestamp of acoustic signals recorded by the respective target device.

Although FIG. 13 illustrates an example method 1300 for accurate virtual mapping for distributed heterogeneous devices with speaker and microphone, various changes may be made to FIG. 13. For example, while shown as a series of steps, various steps in FIG. 13 could overlap, occur in parallel, occur in a different order, or occur any number of times.

As a particular example, the system performing the method 1300 can further include the set of target devices, such that each respective target device performs procedures that are part of the 1300. Each respective target device comprises: a second transceiver configured to receive control signals from the transceiver, the control signals indicating a specified listen start time, a specified play-start time, and a specified listen stop time; a pairing of a speaker and microphone; a local memory; and a second processor (such as the processor within the second electronic device 102 or the processor 340 within the UE 300). To implement the method 1300, the second processor 340 can generate a first local timestamp (t^{r}) of sending a first command to start the microphone to record audio, wherein the microphone starts to record audio at a listen start time

$$( {t}_{G}^{r} ) .$$

The second processor 340 can generate second local timestamp (t^{s}) of sending a second command to start to the speaker to emit a predefined acoustic signal, wherein the speaker starts to emit the predefined acoustic signal at a play-start time

$$( {t}_{G}^{s} ) .$$

The second processor 340 can detect a sample index, within an acoustic waveform that the respective target device recorded and sampled, at which the respective target device detected a beginning of a predefined acoustic signal emitted from each among the set of target devices. The second processor 340 can transmit, from the second transceiver to the transceiver, an audio file that includes the first and second local timestamps and the detected samples.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A system comprising:
a transceiver; and
a processor operably connected to the transceiver and configured to:
control a set of target devices to emit or measure acoustic signals, each target device having a capability of emitting and receiving acoustic signals;
process the acoustic signals to at least reduce random jitters, clock offsets, or both the random jitters and the clock offsets;
determine pairwise distances for the set of target devices based on the processed acoustic signals; and
map the pairwise distances for each target device among the set of target devices into distances between a set of points in a multidimensional space.

2. The system of claim 1, wherein the processor is further configured to:
generate a geometric representation that at least partially matches respective positions of the target devices among the set of target devices; and
determine at least one orientation of the geometric representation based on pairwise distances for the set of target devices.

3. The system of claim 2, the processor is further configured to:
select a correct orientation from among the at least one orientation of the geometric representation, based on at least one of:
a user selection received via a user interface (UI) interactor that displays each from among the at least one orientation of the geometric representation; or
layout information received from an external device, the layout information including respective positions of the set of target devices mapped to a layout of a physical environment.

4. The system of claim 1, wherein to control the set of target devices to measure acoustic signals, the processor is further configured to:
control a microphone within a respective target device among the set of target devices to start to record acoustic signals at a specified listen start time; and
control the microphone within the respective target device to stop recording acoustic signals at a specified listen stop time.

5. The system of claim 1, wherein to control the set of target devices to emit acoustic signals, the processor is further configured to:
iteratively control a speaker within a respective target device among the set of target devices to start to emit a predefined acoustic signal at a specified play-start time until everyone among the set of target devices has emitted the predefined acoustic signal at different play-start times.

6. The system of claim 1, wherein the processor is further configured to collect measurements of the acoustic signals from a respective target device among the set of target devices, including at least one of:
a recording of an acoustic waveform received by a microphone of the respective target device;
an indication of sample indices, within the acoustic waveform that the target device recorded and sampled, at which the respective target device detected a beginning of a predefined acoustic signal emitted from each among the set of target devices;
an indication of a distance between a pairing of a speaker and microphone of the respective target device;
an indication of a sampling rate of the acoustic waveform that the target device recorded and sampled; or
an indication of a start time of recording the acoustic signal by a local clock of the respective target device.

7. The system of claim 6, wherein to determine a subset among the pairwise distances for the set of target devices, the processor is further configured to determine, based on the collected measurements of the acoustic signals from the respective target device, pairwise distances between the respective target device and each of the others among the set of target devices; and
wherein to determine the subset as the pairwise distances between the respective target device and each of the others among the set of target devices, the processor is further configured to reduce an impact of clock offsets and processing delays of the collected measurements, including to at least one of:
detect, within the recording of the acoustic waveform collected from the respective target device, a beginning of a predefined acoustic signal emitted from each among the set of target devices and assign sample indices to the detected beginnings, respectively;
determine the subset as the pairwise distance as a function of the sample indices assigned to the detected beginnings, the indication of the sampling rate of the acoustic waveform, the indication of the distance between the pairing of the speaker and microphone of the respective target device, another indication of a distance between a pairing of a speaker and microphone of the other among the set of target devices, and speed of sound; or
determine both a clock drift of the local clock of the respective target device with respect to a global reference clock, and based on the clock drift, a timestamp of acoustic signals recorded by the respective target device.

8. The system of claim 1, wherein among the set of target devices, each respective target device comprises:
a second transceiver configured to receive control signals from the transceiver, the control signals indicating a specified listen start time, a specified play-start time, and a specified listen stop time;
a pairing of a speaker and microphone;
a local memory; and
a second processor configured to:
generate a first local timestamp (t^{r}) of sending a first command to start the microphone to record audio, wherein the microphone starts to record audio at a listen start time
$$( {t}_{G}^{r} ) ;$$
generate second local timestamp (t^{s}) of sending a second command to start to the speaker to emit a predefined acoustic signal, wherein the speaker starts to emit the predefined acoustic signal at a play-start time
$$( {t}_{G}^{s} ) ;$$
detect a sample index, within an acoustic waveform that the respective target device recorded and sampled, at which the respective target device detected a beginning of a predefined acoustic signal emitted from each among the set of target devices; and
transmit, from the second transceiver to the transceiver, an audio file that includes the first and second local timestamps and the detected samples.

9. A method implemented by at least one processor operably connected to a transceiver, the method comprising:
controlling a set of target devices to emit or measure acoustic signals, each target device having a capability of emitting and receiving acoustic signals;
processing the acoustic signals to at least reduce random jitters, clock offsets, or both the random jitters and the clock offsets;
determining pairwise distances for the set of target devices based on the processed acoustic signals; and
mapping the pairwise distances for each target device among the set of target devices into distances between a set of points in a multidimensional space.

10. The method of claim 9, further comprising:
generating a geometric representation that at least partially matches respective positions of the target devices among the set of target devices; and
determining at least one orientation of the geometric representation based on pairwise distances for the set of target devices.

11. The method of claim 10, further comprising:
selecting a correct orientation from among the at least one orientation of the geometric representation, based on at least one of:
a user selection received via a user interface (UI) interactor that displays each from among the at least one orientation of the geometric representation; or
layout information received from an external device, the layout information including respective positions of the set of target devices mapped to a layout of a physical environment.

12. The method of claim 9, wherein controlling the set of target devices to measure acoustic signals further comprises:
controlling a microphone within a respective target device among the set of target devices to start to record acoustic signals at a specified listen start time; and
controlling the microphone within the respective target device to stop recording acoustic signals at a specified listen stop time.

13. The method of claim 9, wherein controlling the set of target devices to emit acoustic signals further comprises:
iteratively controlling a speaker within a respective target device among the set of target devices to start to emit a predefined acoustic signal at a specified play-start time until everyone among the set of target devices has emitted the predefined acoustic signal at different play-start times.

14. The method of claim 9, further comprising:
collecting measurements of the acoustic signals from a respective target device among the set of target devices, including at least one of:
a recording of an acoustic waveform received by a microphone of the respective target device;
an indication of sample indices, within the acoustic waveform that the target device recorded and sampled, at which the respective target device detected a beginning of a predefined acoustic signal emitted from each among the set of target devices;
an indication of a distance between a pairing of a speaker and microphone of the respective target device;
an indication of a sampling rate of the acoustic waveform that the target device recorded and sampled; or
an indication of a start time of the recording of the acoustic signal by a local clock of the respective target device.

15. The method of claim 14, wherein determining a subset among the pairwise distances for the set of target devices further comprises determining, based on the collected measurements of the acoustic signals from the respective target device, pairwise distances between the respective target device and each of the others among the set of target devices; and
wherein determining the subset as the pairwise distances between the respective target device and each of the others among the set of target devices further comprises reducing an impact of clock offsets and processing delays of the collected measurements, by at least one of:
detecting, within the recording of the acoustic waveform collected from the respective target device, a beginning of a predefined acoustic signal emitted from each among the set of target devices and assign sample indices to the detected beginnings, respectively;
determining the subset as the pairwise distance as a function of the sample indices assigned to the detected beginnings, the indication of the sampling rate of the acoustic waveform, the indication of the distance between the pairing of the speaker and microphone of the respective target device, another indication of a distance between a pairing of a speaker and microphone of the other among the set of target devices, and the speed of sound; or
determining both a clock drift of the local clock of the respective target device with respect to a global reference clock, and based on the clock drift, a timestamp of acoustic signals recorded by the respective target device.

16. A non-transitory computer readable medium embodying a computer program, the computer program comprising computer readable program code that when executed causes a processor of an electronic device to:
control a set of target devices to emit or measure acoustic signals, each target device having a capability of emitting and receiving acoustic signals;
process the acoustic signals to at least reduce random jitters, clock offsets, or both the random jitters and the clock offsets;
determine pairwise distances for the set of target devices based on the processed acoustic signals; and
map the pairwise distances for each target device among the set of target devices into distances between a set of points in a multidimensional space.

17. The non-transitory computer readable medium of claim 16, further containing program code that when executed causes the processor to:
generate a geometric representation that at least partially matches respective positions of the target devices among the set of target devices; and
determine at least one orientation of the geometric representation based on pairwise distances for the set of target devices.

18. The non-transitory computer readable medium of claim 17, further containing program code that when executed causes the processor to:
select a correct orientation from among the at least one orientation of the geometric representation, based on at least one of:
a user selection received via a user interface (UI) interactor that displays each from among the at least one orientation of the geometric representation; or
layout information received from an external device, the layout information including respective positions of the set of target devices mapped to a layout of a physical environment.

19. The non-transitory computer readable medium of claim 16, wherein the program code that when executed causes the processor to control the set of target devices to measure acoustic signals further comprises program code that when executed causes the processor to:
control a microphone within a respective target device among the set of target devices to start to record acoustic signals at a specified listen start time; and
control the microphone within the respective target device to stop recording acoustic signals at a specified listen stop time.

20. The non-transitory computer readable medium of claim 16, wherein the program code that when executed causes the processor to control the set of target devices to emit acoustic signals further comprise program code that when executed causes the processor to:
iteratively control a speaker within a respective target device among the set of target devices to start to emit a predefined acoustic signal at a specified play-start time until everyone among the set of target devices has emitted the predefined acoustic signal at different play-start times.
